(19) United States
(12) Patent Application Publication
(10) Pub. No.: US 2019/0243057 A1
(43) Pub. Date: Aug. 8, 2019

(54) DISPLAY PANEL ILLUMINATION

(71) Applicant: HEWLETT-PACKARD DEVELOPMENT COMPANY, L.P., HOUSTON, TX (US)

(72) Inventors: WEI-KUANG CHU, TAIPEI CITY (TW); KUAN-TING WU, TAIPEI CITY (TW); KOU-CHIH HUANG, TAIPEI CITY (TW)

(21) Appl. No.: 16/325,305

(22) PCT Filed: Oct. 26, 2016
(86) PCT No.: PCT/US2016/058766

§ 371 Date: Feb. 13, 2019

(51) Int. Cl. F21V 8/00

(52) U.S. Cl. CPC G02B 6/0076; G02B 6/0043; G02B 6/0068; G02B 6/0051; G02B 6/0065; G02B 6/0038

(57) ABSTRACT

The present subject matter describes illuminating a display panel. In an example implementation, a plurality of light guide films is stacked together, with a light guide film positioned over another light guide film of the plurality of light guide films. Each of the light guide films of the plurality is associated with a light source. The light source for a respective light guide film is to launch light through at least one light incident surface of the respective light guide film, where the light guide assembly is to guide light from the light source to illuminate the display panel.

### BACKGROUND

Display devices may include a display panel for presenting information in a visual form. Display devices may receive the information in an electrical form and render a visual demonstration of that information on the display panel. Electronic devices, such as televisions, computers, laptops, smart phones, and the like, may include display devices to exhibit the information processed by the electronic devices.

### BRIEF DESCRIPTION OF DRAWINGS

The following detailed description references the drawings, wherein:

FIG. 1 illustrates a sectional view of a backlight unit for illuminating a display panel, according to an example implementation of the present subject matter;

FIG. 2 illustrates a sectional view of a backlight unit for illuminating a display panel, according to another example implementation of the present subject matter;

FIG. 3 illustrates a sectional view of a backlight unit coupled to a display panel, according to an example implementation of the present subject matter;

FIG. 4 illustrates a display device, according to an example implementation of the present subject matter; and

FIG. 5 illustrates an electronic device, according to an example implementation of the present subject matter.

### DETAILED DESCRIPTION

Display devices may include a display panel, such as a Liquid Crystal Display (LCD) panel. The display panel may be illuminated by a lighting unit coupled to the display panel. The lighting unit may include a light source and a light guiding mechanism to direct light from the light source to the display panel for illuminating it. The light source may be, for example, a collection of Light Emitting Diodes (LEDs).

Display devices, such as Field Sequential Color (FSC) based display devices, may have an LCD panel coupled to a backlight unit which illuminates the LCD panel. The backlight unit of such FSC based display devices may include Red-Green-Blue (RGB) LEDs to launch light through a light guide. The RGB LEDs may be illuminated in a specific sequence for a specific time period to produce different colors. The light from the LEDs may travel through the light guide and illuminate the LCD panel to present a visual output with distinct colors.

Generally, the FSC based display devices having a single light guide may experience color breakup which may give rise to colored fringes at the edges of an object in a displayed visual and thereby result in poor quality of the displayed visual. The color breakup may be further prominent when a viewer tracks a moving object in the displayed visual. The color breakup may also result in reduced resolution, poor contrast, and thereby affect the quality of the displayed visual.

The present subject matter relates to backlight units, display devices, and electronic devices having such backlight units. The backlight units of the present subject matter may display visuals with reduced color breakup and increased brightness. The reduced color breakup and increased brightness improve the resolution and contrast of a displayed visual, thereby improving the overall visual quality.

In an example implementation, a backlight unit of the present subject matter includes a light guide assembly. The light guide assembly has a plurality of light guide films stacked together, with a light guide film over another light guide film. Each of the light guide films has a light source associated with it. The light source for a respective light guide film is positioned to launch light through at least one light incident surface of the respective light guide film. A light incident surface of a light guide film may be a surface of the light guide film through which light can be launched into the light guide film. Launching of light into a light guide film may refer to directing light to be incident on the light incident surface of the light guide film, such that the light incident on the light incident surface travels through the light guide film. In an example implementation, the light source may be a collection of light emitting diodes (LEDs), such as RGB LEDs, or RGB organic LEDs (OLEDs). Light from the light source associated with each light guide film is guided through the respective light guide film and thus through the light guide assembly to illuminate a display panel, such as an LCD panel.

The backlight units of the present subject matter, with multiple light guide films stacked together and each light guide film associated with its respective light source, reduce color breakup in displayed visuals. With reduced color breakup the displayed visuals may have a higher contrast and a better resolution. The backlight units of the present subject matter also facilitate in displaying visuals over a wide gamut of colors which may offer flexible color selection. Further, the backlight units of the present subject matter also help in increasing the brightness of the displayed visuals. The reduced color breakup, wider color gamut, and increased brightness of visuals rendered by display devices having the backlight units of the present subject matter improve the overall quality of the displayed visuals.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

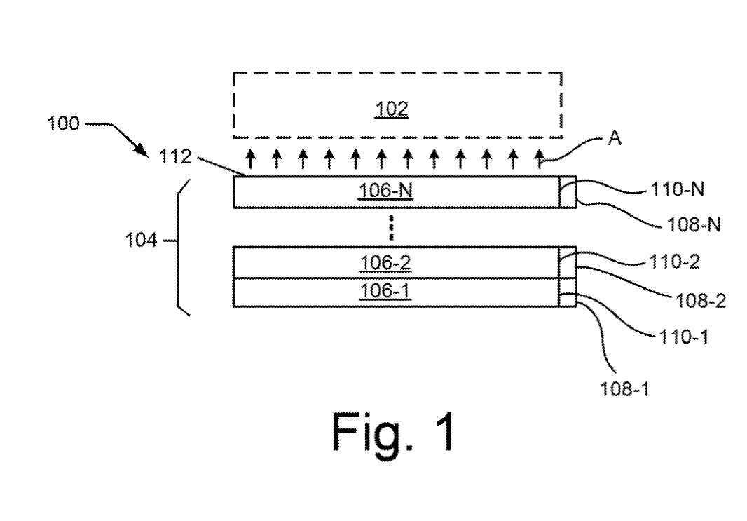

FIG. 1 illustrates a sectional view of a backlight unit 100 for illuminating a display panel 102, according to an example implementation of the present subject matter. The backlight unit 100, in an example implementation, can be coupled to the display panel 102 for illuminating the display panel 102. The backlight unit 100 may be included in a display device, such as a monitor, or in an electronic device, such as a laptop, a smart phone, or the like.

The backlight unit 100 includes a light guide assembly 104 having a plurality of light guide films, viz., 106-1, 106-2, . . . , 106-N stacked together. As shown, a light guide film 106-2 is over another light guide film 106-1, and so on, to form a stack of light guide films. In an example implementation, the light guide assembly 104 may include two light guide films or more than two light guide films. Each of the light guide films 106-1, 106-2, . . . , 106-N may be made of a material selected from a group comprising of one of polycarbonate, polymethylmethacrylate (PMMA), cyclic olefin copolymer (COC), and glass. Further, each of the light guide films 106-1, 106-2, . . . , 106-N may have a refractive index in a range of about 1.45 to about 1.65 and a thickness in a range of about 0.05 mm to about 1.0 mm.

The backlight unit 100 includes a light source associated with each light guide film from the plurality of light guide films 106-1, 106-2, . . . , 106-N. As shown in FIG. 1, a light source 108-1 is associated with the light guide film 106-1 to launch light through a light incident surface 110-1 of the light guide film 106-1. Similarly, a light source 108-2 is associated with the light guide film 106-2 to launch light through a light incident surface 110-2 of the light guide film 106-2. Further, a light source 108-N is associated with the light guide film 106-N to launch light through a light incident surface 110-N of the light guide film 106-N.

A light incident surface may refer to a surface of a light guide film through which light can be launched in the light guide film. In an example implementation, each of the light guide films 106-1, 106-2, . . . , 106-N may have a planar structure with two planar surfaces opposite to each other and four side surfaces along the boundaries of the planar surfaces. The light incident surface of a light guide film may be any of the side surfaces of the respective light guide film. The light source may either be in a direct contact with the light incident surface or be placed in the vicinity of the light incident surface for launching the light. Each of the light sources 108-1, 108-2, and 108-N may be, for example, a plurality of RGB LEDs or a plurality of organic RGB LEDs (OLEDs).

Light launched into the light guide film 106-1 by the light source 108-1 is directed towards the light guide film 106-2 stacked over the light guide film 106-1. Light from the light guide film 106-1 and light launched by the light source 108-2 associated with the light guide film 106-2 enter the light guide film 106-2. The light entering the light guide film 106-2 is directed through the light guide assembly 104 towards the display panel 102. In this way, the light guide film 106-N may receive light from a light guide film located under the light guide film 106-N and light launched by the light source 108-N associated with the light guide film 106-N. Thus, the light guide assembly 104 may guide light from each of the light sources, 108-1, 108-2, . . . 108-N towards a light emitting surface 112 of the light guide assembly 104 to illuminate the display panel 102. The light from the light guide assembly 104, as shown by arrows A in FIG. 1, emanates through the light emitting surface 112 and illuminates the display panel 102.

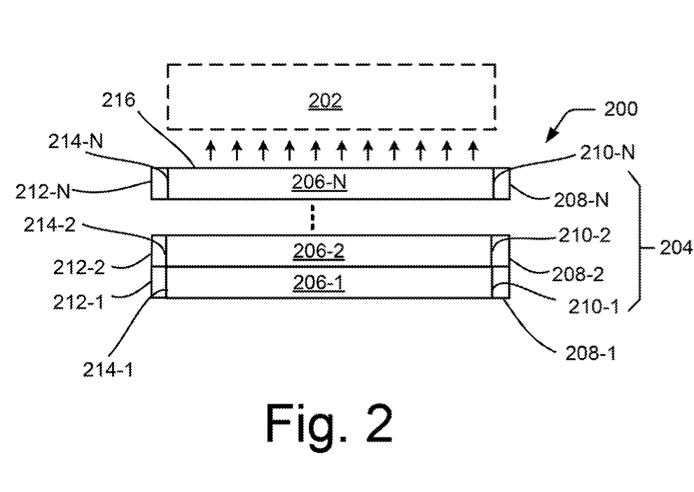

FIG. 2 illustrates a backlight unit 200 for illuminating a display panel 202, according to an example implementation of the present subject matter. The backlight unit 200 includes a light guide assembly 204 having a plurality of light guide films 206-1, 206-2, . . . , 206-N, similar to the plurality of light guide films 106-1, 106-2, . . . , 106-N.

As shown in FIG. 2, two light sources 208-1 and 212-1 are associated with the light guide film 206-1. In an example implementation, the light source 208-1 is positioned to launch light through a first light incident surface 210-1 of the light guide film 206-1 and the light source 212-1 is positioned to launch light through a second light incident surface 214-1 of the light guide film 206-1. Similarly, as shown in FIG. 2, two light sources 208-2 and 212-2 are associated with the light guide film 206-2. The light source 208-2 is positioned to launch light through a first light incident surface 210-2 of the light guide film 206-2 and the light source 212-2 is positioned to launch light through a second light incident surface 214-2 of the light guide film 206-2. Further, as shown in FIG. 2, two light sources 208-N and 212-N are associated with the light guide film 206-N. The light source 208-N is positioned to launch light through a first light incident surface 210-N of the light guide film 206-N and the light source 212-N is positioned to launch light through a second light incident surface 214-N of the light guide film 206-N.

Each of the light guide films 206-1, 206-2, . . . , 206-N may have a planar structure with two planar surfaces and four side surfaces, similar to the structure of each of the light guide films 106-1, 106-2, . . . , 106-N, as described earlier. Although, in FIG. 2, each of the light guide films 206-1, 206-2, . . . 206-N is shown to be associated with light sources at two different light incident surfaces, however, in an example implementation, each of the light guide films 206-1, 206-2, . . . 206-N may be associated with light sources at more than two light incident surfaces. In an example implementation, all four side surfaces of each of the light guide films 206-1, 206-2, . . . 206-N may be light incident surfaces. Further in FIG. 2, although the light sources are coupled to two opposite side surfaces of each light guide film 206-1, . . . , 206-N, however, in an example implementation, light sources may also be coupled to two adjacent side surfaces of each of the light guide films 206-1, . . . , 206-N. The light guide assembly 204 guides light in a similar manner, as the light guide assembly 104, and thus illuminates the display panel 202.

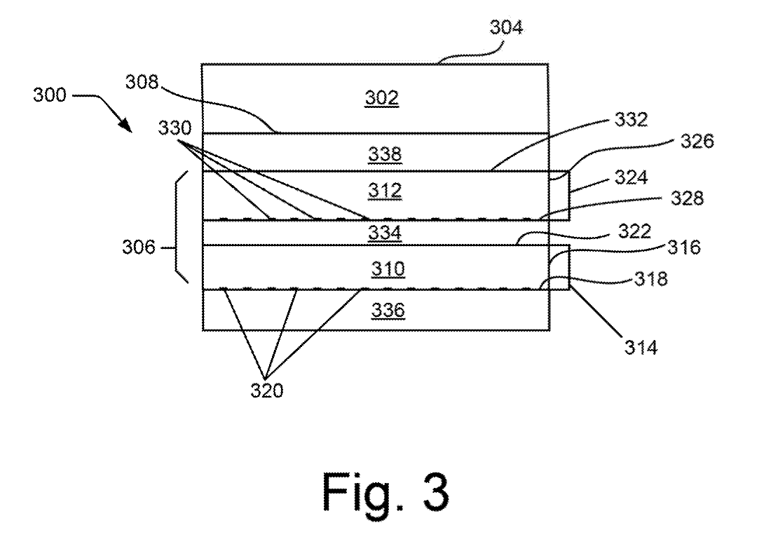

FIG. 3 illustrates a sectional view of a backlight unit 300 coupled to a display panel 302, according to an example implementation of the present subject matter. In an example implementation, the display panel 302 is a field sequential color liquid crystal display (FSC-LCD) panel. The display panel 302 has a display surface 304. The display surface 304 may refer to a surface of the display panel 302 on which a visual may be rendered and viewed by a user.

The backlight unit 300 includes a light guide assembly 306 located on a surface 308 opposite to the display surface 304 of the display panel 302. The light guide assembly 306 has a first light guide film 310 and a second light guide film 312. The second light guide film 312 is stacked over the first light guide film 310.

The light guide assembly 306 includes a first light source 314 associated with the first light guide film 310. The first light source 314 can launch light through a light incident surface 316 of the first light guide film 310, such that the light launched through the light incident surface 316 is guided through the first light guide film 310.

The first light guide film 310 has a first surface 318 bearing light guide microstructures 320. The first surface 318 may be a bottom surface of the first light guide film 310. In an example implementation, the light guide microstructures 320 are micro-dots or lines formed in a specific pattern by one of chemical or laser etching, laser printing, screen printing, and v-cutting on the first surface 318. The first surface 318 bearing patterns of micro-dots and/or strips is also referred to as a micro-patterned surface of the first light guide film 310. The light guide microstructures 320 diffuse or scatter light guided through the first light guide film 310 to direct the light towards a second surface 322, opposite to the first surface 318, of the first light guide film 310. Light directed by the light guide microstructures 320 towards the second surface 322 may emit through the second surface 322. Thus, the second surface 322 may also be referred to as a light emitting surface of the first light guide film 310.

The light guide assembly 306 further includes a second light source 324 associated with the second light guide film 312. The second light source 324 can launch light through a light incident surface 326 of the second light guide film 312, such that the light launched through the light incident surface 326 is guided through the second light guide film 312.

The second light guide film 312 has a third surface 328 bearing light guide microstructures 330. The third surface 328 may be a bottom surface of the second light guide film 312. In an example implementation, the light guide microstructures 330 are similar to the light guide microstructures 320 of the first light guide film 310 and may be formed by similar processes as mentioned above. The third surface 328 bearing patterns of the micro-dots and strips is also referred to as a micro-patterned surface of the second light guide film 312. The light guide microstructures 330 diffuse or scatter light guided through the second light guide film 312 to direct the light towards a fourth surface 332, opposite to the third surface 328, of the second light guide film 312. Light directed by the light guide microstructures 330 towards the fourth surface 332 may emit through the fourth surface 332. Thus, the fourth surface 332 may also be referred to as a light emitting surface of the second light guide film 312.

In an example implementation, the second surface 322 of the first light guide film 310 is coupled to or joined with the third surface 328 of the second light guide film 312 by an optically clear adhesive (OCA) layer 334 as shown in FIG. 3. The OCA layer 334 may have a thickness in a range of about 0.01 mm to about 0.05 mm.

In an example implementation, each of the first and the second light guide films 310 and 312 may be made of a material selected from a group comprising polycarbonate, polymethylmethacrylate (PMMA), cyclic olefin copolymer (COC), and glass, and may have a refractive index in a range of about 1.45 to about 1.65. Each of the first light guide film 310 and the second light guide film 312 may have a thickness in a range of about 0.05 mm to about 1.0 mm.

In an example implementation, each of the first and second light sources 314 and 324 may be one of a plurality of RGB-LEDs and a plurality of RGB-OLEDs. The light sources may be driven by a controller (not shown) using a Field Sequential Color (FSC) control logic.

The backlight unit 300, shown in FIG. 3, includes a reflector 336 interfaced with the first surface 318 of the first light guide film 310. In an example implementation, the reflector 336 may be formed from one of polyethylene terephthalate (PET) and polyimide coated with reflective materials and may have a thickness in a range of about 0.02 mm to about 1.5 mm. The reflector 336 reflects back light from any of the first and second light sources 314 and 324 incident on the reflector 336 towards the first surface 318.

As shown in FIG. 3, the backlight unit 300, also has a diffuser film 338 interfaced with the fourth surface 332 of the second light guide film 312. In an example implementation, the diffuser film 338 may be formed from one of polycarbonate, polyethylene terephthalate (PET), polymethylmethacrylate (PMMA) and cyclic olefin copolymer (COC) and may have a thickness in a range of about 0.08 mm to about 1.5 mm. The diffuser film 338 enables uniform distribution of light emanating from the fourth surface 332 onto the display panel 302.

The light launched into the first light guide film 310 by the first light source 314, when incident on the light guide microstructures 320, is directed by the light guide microstructures 320 towards the second surface 322 of the first light guide film 310. The light scattered by the light guide microstructures 320 emits through the second surface 322. The light emitted through the second surface 322 passes through the OCA layer 334 and enters the second light guide film 312 through the third surface 328. The light entering the second light guide film 312 through the third surface 330 may be guided towards the fourth surface 332 of the second light guide film 312.

The light launched into the second light guide film 312 by the second light source 324, when incident on the light guide microstructures 330, is directed by the light guide microstructures 330 towards the fourth surface 332. The light scattered by the light guide microstructures 330 emits through the fourth surface 332 of the second light guide film 312.

Thus, the light emanating from the fourth surface 332 may include light launched by the second light source 324 and light entering the second light guide film 312 from the first light guide film 310. The light emanating from the fourth surface 332 may be uniformly distributed by the diffuser film 338 onto the display panel 302 to illuminate the display panel 302.

Although FIG. 3 illustrates the light guide assembly 306 with two light guide films, the light guide assembly may also include more than two light guide films. In an example implementation, a third light guide film (not shown) may be coupled to the second light guide film 312. The third light guide film may have material properties, features, and dimensions similar to those of the first or the second light guide films, 310 and 312. In an example implementation, the third light guide film (not shown) may have a surface coupled to or joined with the fourth surface 332 of the second light guide film 312 through an optically clear adhesive (OCA) layer similar to the OCA layer 334. The surface of the third light guide film coupled to the fourth surface 332 may bear light guide microstructures similar to light guide microstructures 330 or 320 and may be referred to as a micro-patterned surface of the third light guide film. The third light guide film includes a light emitting surface, opposite to its micro-patterned surface, through which light guided through the third light guide film may be emitted. In the example implementation with three light guide films, the light emitting surface of the third light guide film may be coupled with the display panel through a diffuser film similar to the diffuser film 338. Light emanating from the light emitting surface of the third light guide film may be uniformly distributed by the diffuser film onto the display panel to illuminate the display panel.

Further, although, FIG. 3 shows one light source associated with each of the light guide films; however, in an example implementation, more than one light source may be associated with each light guide film.

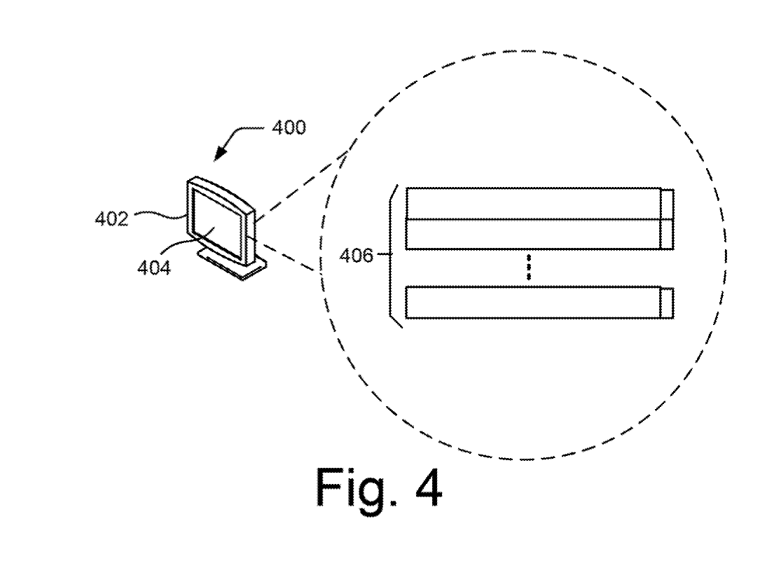

FIG. 4 illustrates a display device 400, according to an example implementation of the present subject matter. In an example implementation, the display device 400 may be a monitor, a display screen of an electronic device, such as a computer, laptop, smart phone, television, or the like. The display device 400 has a display panel 402 with a display surface 404 on which visuals are rendered by the display device 400 for viewing by users. As shown in FIG. 4, a light guide assembly 406 is located on a surface (not shown), opposite to the display surface 404, of the display panel 402. In an example implementation, the light guide assembly 406 may be similar to one of the light guide assemblies described earlier.

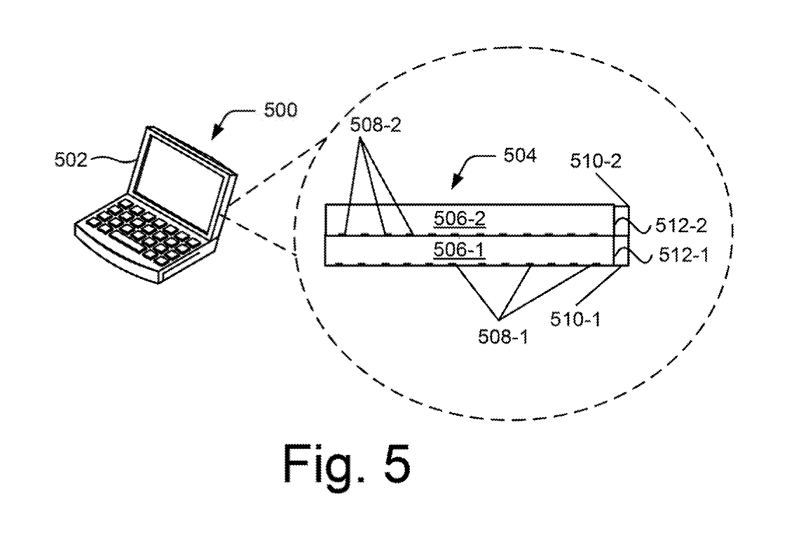

FIG. 5 illustrates an electronic device 500, according to an example implementation of the present subject matter. The electronic device 500 may be a television, a computer, a laptop, a smart phone etc. The electronic device 500 includes a display panel 502 and a backlight unit 504 coupled to the display panel 502 to illuminate the display panel 502. The backlight unit 504 includes a first light guide film 506-1 and a second light guide film 506-2. The second light guide film 506-2 is coupled to the first light guide film 506-1.

Each of the first and second light guide films, 506-1 and 506-2, bear light guide microstructures 508-1 and 508-2, respectively. In an example implementation, the first and second light guide films 506-1 and 506-2 may be similar to the light guide films described earlier.

The backlight unit 504 includes a first set of light sources to launch light through the first light guide film 506-1. The first set of light sources may include one light source 510-1 associated with the first light guide film 506-1 to launch light through a light incident surface 512-1 of the first light guide film 506-1, as shown in FIG. 5. The first set of light sources may also include other light sources which may be coupled to other light incident surfaces of the first light guide film 506-1.

The backlight unit 504 further includes a second set of light sources to launch light through the second light guide film 506-2. The second set of light sources may include one light source 510-2 associated with the second light guide film 506-2 to launch light through a light incident surface 512-2 of the second light guide film 506-2, as shown in FIG. 5. The second set of light sources may also include other light sources which may be coupled to other light incident surfaces of the second light guide film 506-2.

In an example implementation, the backlight unit 504 may include a third light guide film (not shown) over the second light guide film 506-2. The back light unit 504 may include a third set of light sources to launch light through the third light guide film. The third set of light sources may include one light source or multiple light sources, each positioned to launch light through a respective light incident surface of the third light guide film (not shown).

In an implementation, the backlight unit 504 may be similar to the backlight units described earlier. The backlight unit 504 may function in a similar manner as the backlight units described earlier.

Although implementations for backlight units, display devices, and electronic devices having such backlight units are described in language specific to methods and/or structural features, it is to be understood that the present subject matter is not limited to the specific methods or features described. Rather, the methods and specific features are disclosed and explained as example implementations for backlight units, display devices, and electronic devices having such backlight units.

I/We claim:

1. A backlight unit comprising:
a light guide assembly having a plurality of light guide films stacked together, with a light guide film positioned over another light guide film of the plurality of light guide films; and
a light source associated with each light guide film of the plurality of light guide films, wherein the light source for a respective light guide film is to launch light through at least one light incident surface of the respective light guide film;
wherein the light guide assembly is to guide light from the light source to illuminate a display panel.

2. The backlight unit as claimed in claim 1, wherein the plurality of light guide films comprises:
a first light guide film including a first surface bearing light guide microstructures to direct light guided through the first light guide film towards a second surface of the first light guide film, wherein the second surface is opposite to the first surface; and
a second light guide film over the first light guide film, the second light guide film including a third surface bearing light guide microstructures to direct light guided through the second light guide film towards a fourth surface of the second light guide film, wherein the fourth surface is opposite to the third surface.

3. The backlight unit as claimed in claim 2, further comprising a diffuser film interfaced with the fourth surface of the second light guide film, wherein the diffuser film is to uniformly distribute light emanating from the fourth surface onto the display panel.

4. The backlight unit as claimed in claim 2, further comprising a reflector interfaced with the first surface of the first light guide film, wherein the reflector is to reflect, light incident on the reflector, towards the first surface.

5. The backlight unit as claimed in claim 2, further comprising an optically clear adhesive layer to join the second surface of the first light guide film with the third surface of the second light guide film.

6. The backlight unit as claimed in claim 1, wherein each of the plurality of light guide films is made of a material selected from a group comprising polycarbonate, polymethylmethacrylate (PMMA), cyclic olefin copolymer (COC), and glass.

7. A display device comprising:
a display panel having a display surface;
a light guide assembly located on a surface of the display panel opposite to the display surface, the light guide assembly comprising a plurality of light guide films stacked together, with a light guide film positioned over another light guide film of the plurality of light guide films; and
a light source associated with each light guide film of the plurality of light guide films, wherein the light source for a respective light guide film is to launch light through at least one light incident surface of the respective light guide film;
wherein the light guide assembly is to guide light from the light source to illuminate the display panel.

8. The display device as claimed in claim 7, wherein the light guide assembly comprises:
a first light guide film including a micro-patterned surface and a light emitting surface opposite to the micro-patterned surface, the micro-patterned surface of the first light guide film bearing microstructures to direct light guided through the first light guide film towards the light emitting surface of the first light guide film; and
a second light guide film over the first light guide film, the second light guide film including a micro-patterned surface and a light emitting surface opposite to the micro-patterned surface, the micro-patterned of the second light guide film bearing microstructures to direct light guided through the second light guide film towards the light emitting surface of the second light guide film.

9. The display device as claimed in claim 8, further comprising:
a diffuser film interfaced with the light emitting surface of the second light guide film, wherein the diffuser film is to uniformly distribute light emanating from the fourth surface onto the display panel; and
a reflector interfaced with the micro-patterned surface of the first light guide film, wherein the reflector is to reflect, light incident on the reflector, towards the first surface.

10. The display device as claimed in claim 8, further comprising an optically clear adhesive layer to join the light emitting surface of the first light guide film with the micro-patterned surface of the second light guide film.

11. An electronic device comprising:
a display panel;
a backlight unit coupled to the display panel to illuminate the display panel, comprising:
a first light guide film including a first surface bearing light guide microstructures to direct light guided through the first light guide film towards a second surface, opposite to the first surface, of the first light guide film; and
a second light guide film coupled to the first light guide film, the second light guide film including a third surface bearing light guide microstructures to direct light guided through the second light guide film towards a fourth surface, opposite to the third surface, of the second light guide film;
a first set of light sources to launch light through the first light guide film; and
a second set of light sources to launch light through the second light guide film.

12. The electronic device as claimed in claim 11, wherein the backlight unit comprises:
a third light guide film, wherein a surface of the third light guide film is coupled to the fourth surface of the second light guide film; and
a third set of light sources to launch light through the third light guide film.

13. The electronic device as claimed in claim 11, wherein the thickness of the first light guide film is in a range of 0.05 mm to about 1.0 mm.

14. The electronic device as claimed in claim 11, wherein the thickness of the second light guide film is in a range of 0.05 mm to about 1.0 mm.

15. The electronic device as claimed in claim 12, wherein the thickness of the third light guide film is in a range of 0.05 mm to about 1.0 mm.
